(19) United States
(12) Patent Application Publication
(10) Pub. No.: US 2007/0250643 A1
(43) Pub. Date: Oct. 25, 2007

(54) Marking feed items in mobile terminals for further reading

(75) Inventors: Seppo Pyhalammi, Helsinki (FI); Tero-Markus Saarimaa, Helsinki (FI); Timo Yliniemi, Espoo (FI); Tuomo Sihvola, Espoo (FI); Kaj Haggman, Espoo (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/410,280

(22) Filed: Apr. 25, 2006

(51) Int. Cl. G06F 15/16

(52) U.S. Cl. 709/245

(57) ABSTRACT

The user of a mobile device is able to mark selected portions of content viewed on the mobile device (e.g., URLs associated with web feeds) for later viewing. The selected portions may be transmitted to a server and used to create a user profile associated with the user. The user profile may be used to send targeted content (e.g., advertising) to the user either at the mobile terminal or at another computer associated with the user of the mobile terminal. The marked portions may be used to view fuller portions of the content (e.g., the contents of a web feed) at a later time.

### FIELD OF THE INVENTION

Embodiments of the invention relate generally to communications networks. More specifically, embodiments of the invention relate to providing information of interest to users of mobile terminals in a communication network.

### BACKGROUND OF THE INVENTION

The process and science of information distribution is heavily relied upon by many industries including the advertising industry. Advertisers seek to distribute their advertisements and information to as many people as possible that may be interested in their product. This typically involves analyzing user profile information to determine whether the benefit of sending the advertisement to users would outweigh the costs. In some instances, advertisements are specifically geared toward one demographic and thus, may be ineffective for another demographic. As such, advertisers must insure that costs are not incurred to advertise with those demographics that are not relevant to a particular advertisement. Electronic advertising has also developed into a key component of many marketing campaigns, because electronic advertising can often be low cost and easily distributed to numerous users at once.

In addition, creative electronic advertising methods such as the use of advertisement widgets have allowed advertisers and target users to strike a balance in the control of advertisement distribution. Advertisement widgets are applications that may be downloaded to a user's computing device such as a mobile phone and that display a variety of information including advertisements. Widgets include graphical elements that are generally displayed in a particular area of a device's user interface. Widgets may further be associated with a content server and receive display content directly from the server based on various factors including user preferences and interests. For example, Yahoo! provides a widget engine that allows a user to run widgets that may perform a multitude of actions and functions.

Even with new developments in advertising technology like the use of widgets, advertisers may often find it difficult to target the most relevant user groups and/or to identify those users who would be receptive to advertisements. Advertisers have not been able to capitalize on information about a particular user inferred from user interactions and behaviors. For example, a user may frequently download and view advertisement widgets relating to consumer electronics. In particular, the user may have a significant collection of widgets relating to electronics. Based on this observation, an advertiser of televisions would most likely want to direct an advertisement to that user. However, the advertiser is often unaware of such behavior, patterns and widget collection information. In addition, many users are often hesitant to sign up for advertisements or use advertisement widgets because they assume their private information (e.g., e-mail address, home telephone number) will be distributed to other advertisers. Further, even when a user is interested in an advertised product, the user is often guarded about signing up for additional information for fear of compromising privacy.

Recently, feed-based services such as Really Simple Syndication (RSS) and Atom have made it easier to obtain updated information on websites of interest to a particular computer user. RSS uses code that scans the content of a website for updates and then broadcasts those updates to subscribers through a feed. Although RSS feeds are normally used with news sites, any website can use them to disseminate information. When an update is sent out, it includes a headline and a small amount of text, either a summary or lead-in to a larger story. The user clicks on a link to read more (e.g., the full story).

When using feed-based services on a mobile terminal, the headline and small amount of text can be easily and quickly viewed on the mobile terminal, but opening the full-text article using a browser can take substantially longer. In addition, the link typically points to a web page containing content other than the article itself, such as banners and links, which makes it still more difficult to be read on the mobile device. It may be more convenient for the user to later read the full content on a different (e.g., desktop) computer with enhanced browsing features and performance. It would be advantageous to permit the user to easily mark content of interest for later viewing, and to couple such marked content with advertising.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In one example, a method is provided for creating a user profile for determining information of interest. For example, a user of an electronic device (e.g., a mobile terminal) marks addresses such as URLs associated with information of interest (e.g., a portion of content such as a title) and the addresses such as URLs are used to generate the user profile.

In another example, a mobile terminal is provided for marking information content to indicate information of interest and receiving information of interest based on the marked information.

In another example, a server is provided for transmitting information of interest to a mobile terminal based on marked information content received from the mobile terminal.

In another example, a computer-readable medium is provided containing instructions for transmitting or receiving information of interest.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a block diagram of a wireless communication system in which various embodiments may be implemented.

FIG. 2 illustrates a suitable mobile terminal/receiver in which one or more illustrative embodiments may be implemented.

FIG. 3 illustrates an example of information displayed on a display of a mobile terminal in which one or more illustrative embodiments may be implemented.

FIG. 4 shows a system employing various principles of the present invention.

FIG. 5 is a partial block diagram illustrating an example of a server providing information content to a mobile terminal according to one or more illustrative embodiments.

FIG. 6 shows various method steps that may be carried out according to aspects of the invention.

FIG. 7 shows how a widget may be selected and associated with a web feed.

FIG. 8 shows how widgets may be created on a server for later use by a user of a mobile device.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

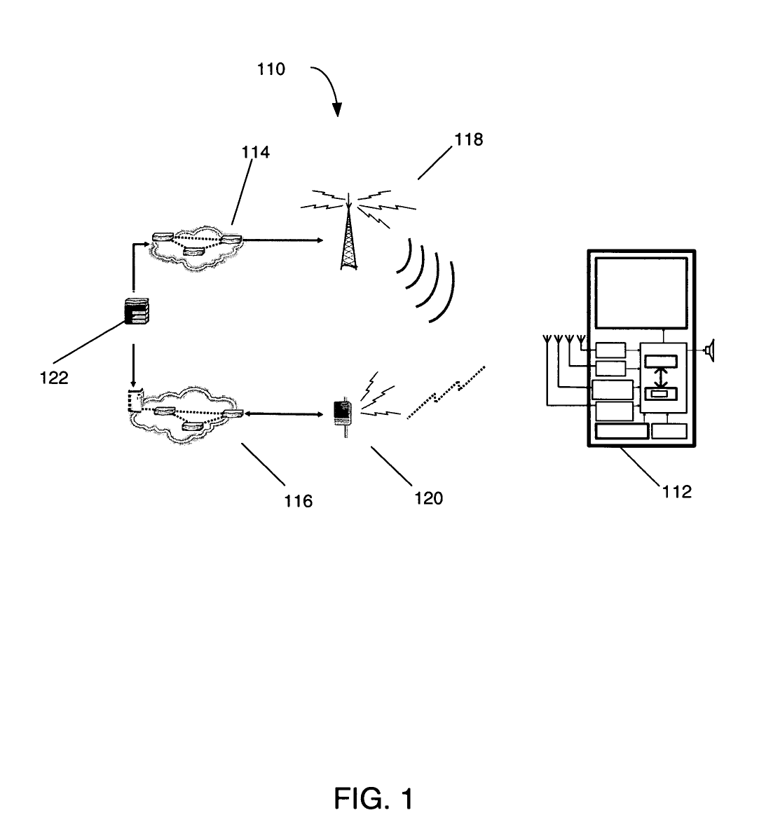

Aspects of the present invention may be utilized across a broad array of networks and communication protocols. FIG. 1 illustrates an example of a wireless communication system 110 in which systems and methods according to at least some embodiments may be employed. One or more network-enabled mobile devices 112, such as a personal digital assistant (PDA), cellular telephone, mobile terminal, personal video recorder, portable television, personal computer, digital camera, digital camcorder, portable audio device, portable radio, or combinations thereof, are in communication with a service source 122 through a broadcast network 114 (which may include the internet or similar network) and/or cellular network 116. The mobile terminal/device 112 may comprise a digital broadband broadcast receiver device. The service source 122 may be connected to several service providers that may provide their actual program content or information or description of their services and programs to the service source that further provides the content or information to the mobile device 112. The several service providers may include but are not limited to one or more television and/or digital television service providers, AM/FM radio service providers, SMS/MMS push service providers, Internet content or access providers.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. One type of DVB is Digital video broadcasting-handheld (DVB-H), a recently developed technology that increases the capabilities and services available on small handheld devices, such as mobile telephones.

The broadcast network 114 may include a radio transmission of IP datacasting over DVB-H. The broadcast network 114 may broadcast a service such as a digital or analog television signal and supplemental content related to the service via transmitter 118. The broadcast network may also include a radio, television or IP datacasting broadcasting network. The broadcast network 114 may also transmit supplemental content which may include a television signal, audio and/or video streams, data streams, video files, audio files, software files, and/or video games. In the case of transmitting IP datacasting services, the service source 122 may communicate actual program content to user device 112 through the broadcast network 114 and additional information such as user right and access information for the actual program content through the cellular network 116 or utilizing both networks.

The mobile device 112 may also contact the service source 122 through the cellular network 116. The cellular network 116 may comprise a wireless network and a base transceiver station transmitter 120. The cellular network may include a second/third-generation (2G/3G) cellular data communications network, a Global System for Mobile communications network (GSM), a Universal Mobile Telecommunications System (UMTS) or other wireless communication network such as a WLAN network.

In one aspect of the invention, mobile device 112 may comprise a wireless interface configured to send and/or receive digital wireless communications within cellular network 116. The information received by mobile device 112 through the cellular network 116 or broadcast network 114 may include user input or selection (for example, in an interactive transmission), applications, services, electronic images, audio clips, video clips, and/or WTAI (Wireless Telephony Application Interface) messages. As part of cellular network 116, one or more base stations (not shown) may support digital communications with receiver device 112 while the receiver device is located within the administrative domain of cellular network 116.

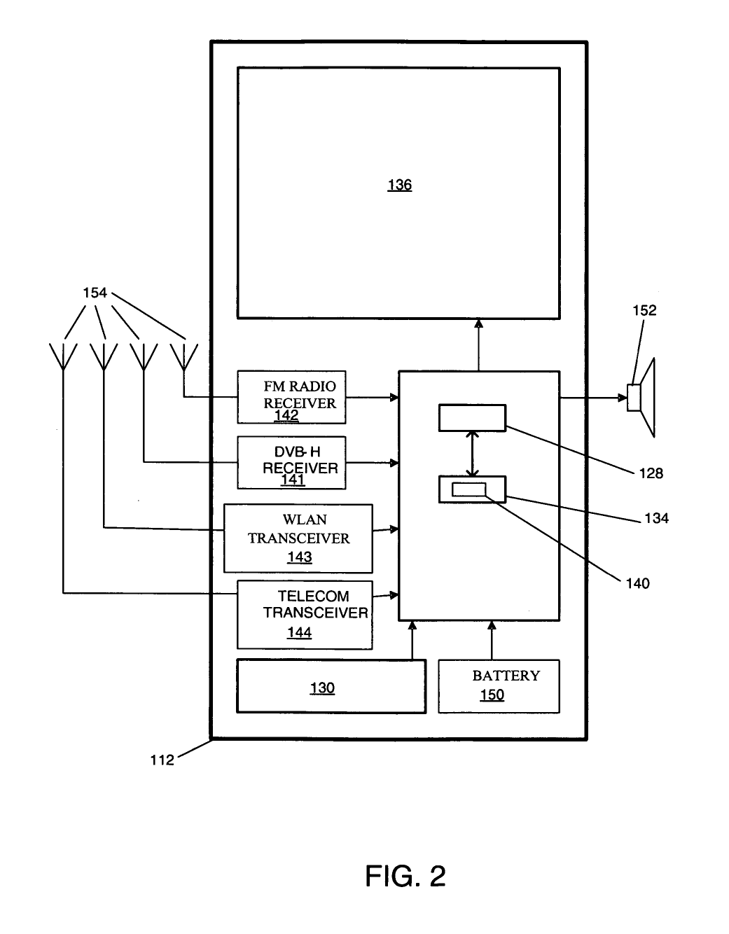

As shown in FIG. 2, mobile device 112 may include a processor 128 connected to a user interface 130, memory 134 and/or other storage, and display 136. Mobile device 112 may also include battery 150, speaker 152 and antennas 154. User interface 130 may further include a keypad, touch screen, voice interface, four arrow keys, joy-stick, stylus, data glove, mouse, roller ball, touch screen, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process digital broadband broadcast transmissions that are based, for example, on the Digital Video Broadcast (DVB) standard, such as DVB-H, DVB-T or DVB-MHP, through a specific DVB receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

One or more web browsers or similar applications may also be provided on the terminal to permit a user to access content on the Internet. Other applications, such as an RSS aggregator or feed reader, may also be provided in the terminal.

In one example of the present invention, a user of a mobile device may desire access to information via the mobile device. The desired information may be displayed on a display device at the mobile terminal in a convenient manner. For example, a system for providing desired information in a mobile device may include a system API through which a third party may provide content to the mobile device. In addition, the system may include a widget API for providing a standardized interface for communication between a user interface display element containing or displaying desired information (i.e., a “widget”). The system API may communicate with the widget via the widget API, for example. Also, the widget may access information on the Internet via the widget API.

User interfaces for displaying or providing up-to-date information (i.e., “widgets”) may be arranged on a display in a designated user interface or predetermined area on a display (e.g., a “dashboard”). The designated user interface, or dashboard, provides delivery of messages from the widget API to the service server. The dashboard may further include a dashboard API for providing access to mobile device resources and for presenting a user interface corresponding to a widget. The dashboard API may contain at least two parts. One part may be an API for the development of widgets such as design, placement on a display, content, etc. Another part of the dashboard API may be provided for third party developers. In another example, the dashboard API may be built over a mobile device operating system or over any other API available on the mobile device. In another example, the system may also include a mobile gateway for creating and maintaining mobile connections between a mobile device and a service. In one embodiment, the dashboard may be larger than the mobile device display, such that only a portion of the dashboard at a time is viewed on the mobile device display. For example, the dashboard may be spread horizontally and can be traversed using arrow keys, a joystick, or similar input device.

In one example, on-line subscription services may be provided from a subscription server to a user of a mobile device through the Internet. The subscription server may receive from the mobile device user-specific information relating to capabilities of the mobile device, user preferences, or other user-related information. The information may be stored as well in the server. For example, the server may know the user's mobile device type and the related mobile device characteristics can be obtained from, for example, a manufacturers' site. The subscription server sends relevant information based on the user information to the mobile device and may receive a request from the mobile device from the user. For example, if a user wishes to purchase a downloadable product, the subscription service may download the desired product to the mobile device based on the request received from the user.

In another example, a mobile terminal may receive and display information via web or content feeds. Web feeds (e.g., RSS or Atom) may be used to exchange information including rapidly changing information. For example, a user may desire up-to-the-minute news from a news source (e.g., major news organizations) and may receive updated information from the news source and display the received information on a display at the mobile terminal. A feed reader or aggregator may check a list of feeds on behalf of a user and display the information found. Such web feed applications may provide updated information in the feed which may contain a title, description and links to further content (e.g., the full story). The information may include a description of a content associated with the web site. If a user desires more information, the user may select a corresponding link to open a web browser window application. Alternatively, a user may select the desired portion of content for marking, as described below.

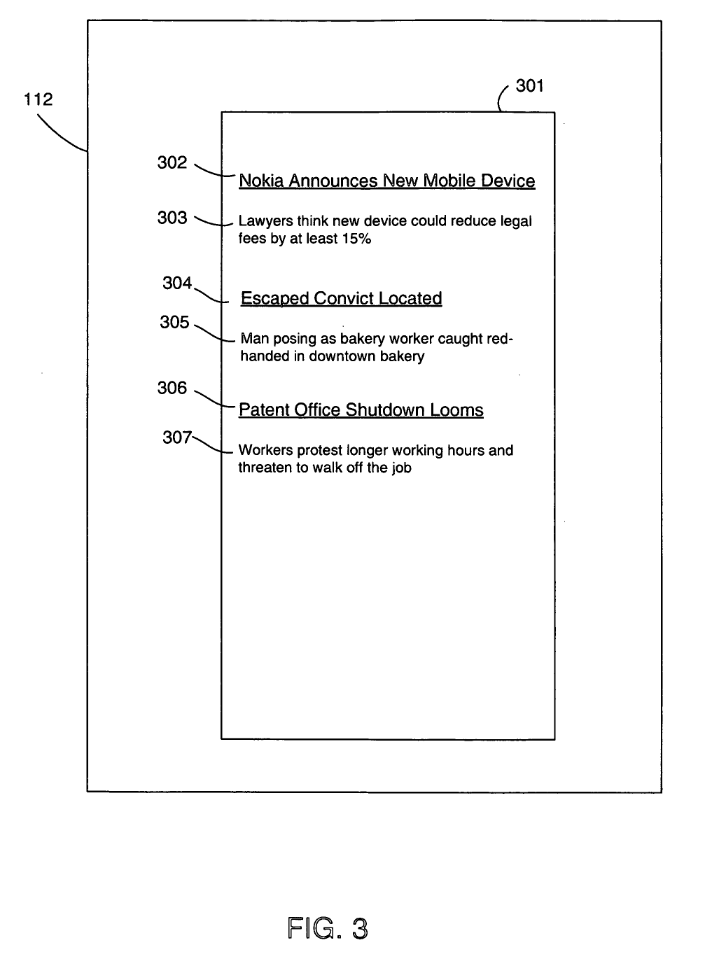

FIG. 3 illustrates an example of information displayed on a display 301 of a mobile terminal 112. In this example, the display 301 may include one or more web feeds, each having a corresponding headline (302, 304, and 306) and brief text summary (303, 305, and 307). Each headline corresponds to a URL pointing to a web site having updated content that may be obtained by selecting (e.g., clicking on) the corresponding URL.

According to one variation of the invention, instead of selecting a corresponding URL, which could take time on the mobile terminal to obtain and render the content, the user can mark one or more web feeds of interest for later viewing, such as from a different computer, e.g. when having a time slot for concentrating on the content. “Marking,” as used herein, refers to identifying (or indicating) displayed information (e.g., a title, a portion of content, web feed, or a content address such as a URL) as having relevance for the user who did the marking. Reference to “marking a content address” encompasses marking not only a URL but marking a title, portion of content, web feed, or other displayed information that is associated with content such as a web feed. Using any of various user input techniques (e.g., stylus, cursors, keyboard, etc.), the user marks one or more web feeds (e.g., URLs) of interest and the marked URL or an identification of the URL is transmitted to a server or other location for later use. In one embodiment, the user may mark a URL of interest and, by pressing a function key or other button, cause the marked URL to be transmitted from the mobile terminal to another computer at another location. Alternatively, the marked URLs may be stored locally in the mobile terminal for later use.

The marked links may be included in a list or user profile. The list or user profile may be further stored either at the mobile terminal or may be transmitted to a remote device. In one example, the list of links that are of interest or potential interest to the user may be transmitted to a server for further processing. At the server, the list of links that are of interest or potential interest to the user may be added to a list of previously indicated links of interest or potential interest to the user. This list may be updated as new information is received. For example, as a user indicates additional subjects of information by selecting corresponding links in web feeds, the newly selected links may be added to the list. The list may thus be used to form a user profile for describing the interests of the user.

New content or partly new content may be provided by the server to the mobile terminal based on the user profile. For example, if the user profile contains several links corresponding to a sport such as hockey, the server may create a user profile that is specific to hockey and use this profile to send targeted advertisements to the mobile terminal relating to hockey.

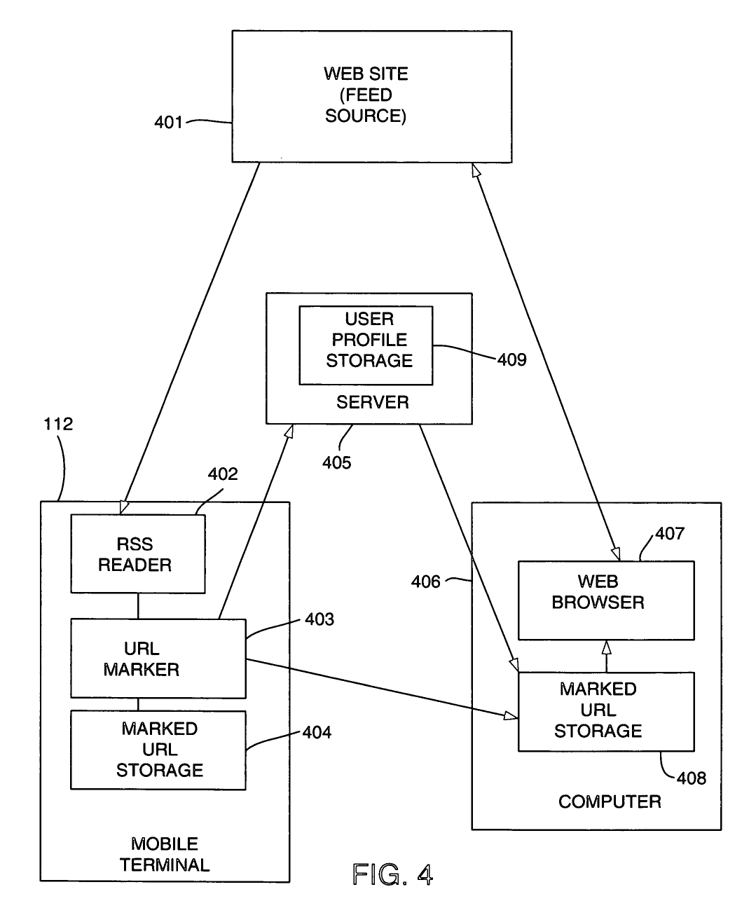

FIG. 4 shows a system and method employing various principles of the invention. A mobile terminal 112 includes an RSS reader 402 that receives updated feed information from one or more web sites 401 and displays it on the device. When a user of mobile terminal 112 sees feed content of interest, the user uses a URL marker function 403 to mark the URL or URLs of interest. In one variation of the invention, the marked URL is transmitted to a server 405, where it is correlated with a user profile 409 (e.g., a user profile is created and/or augmented based on the marked URLs). The marked URL may be further transmitted to another computer 406 (e.g., via email) associated with or identified by the user, wherein the marked URLs are stored in a storage area 408 for later browsing using web browser 407. In another variation, the marked URLs are transmitted from mobile terminal 112 to computer 406 through other means, e.g., Bluetooth or IR connection, WLAN, cable, memory card, etc. In yet another variation, the marked URLs are stored internally in mobile terminal 112 in a marked URL storage area 404 for later use.

User profiles may be generated based on marked URLs in any of various ways. For example, keywords in titles and summaries of web feeds may be used to determine the interests of a particular user (e.g., sports, weather, technology). A user who marks several stories relating to hockey scores, for example, could have a user profile created in which hockey is identified as a topic of interest. Based on the topic or topics of interest, targeted advertising can be generated for the mobile terminal user and/or for the later web browsing such as via web browser 407. Consequently, if the mobile terminal user has marked several stories relating to hockey, when he later uses web browser 407 to view the full stories, the user is presented with targeted advertising relating to hockey (e.g., sports tickets, hockey equipment, etc.). In another variation of the invention, profiles can be created based not only on the links and summaries of web feeds but also on the full-text content of the web feeds. By scanning the web feed for various keywords, a profile can be created based on the content of the web feed.

In one variation of the invention, targeted advertising can be delivered via advertising widgets to the mobile terminal. For example, suppose that a user has activated an advertising widget that permits the user to receive targeted advertising and have it placed on the display of the mobile device in a particular manner and format. According to one embodiment of the invention, after the user has marked various URLs in web feeds, a user profile is created based on the markings, and advertising that matches criteria in the user profile is transmitted to the user via the advertising widget. In yet another embodiment, an existing user profile (e.g., based on the advertising widget) can be updated to include information pertaining to the URLs (or other content addresses) marked by the user. Targeted advertising can also be sent to the mobile device via SMS, email, or any other means.

The user profile may be periodically updated by adding newly selected links of interest and/or by removing selected links of interest from the user profile when the selected links are out-dated.

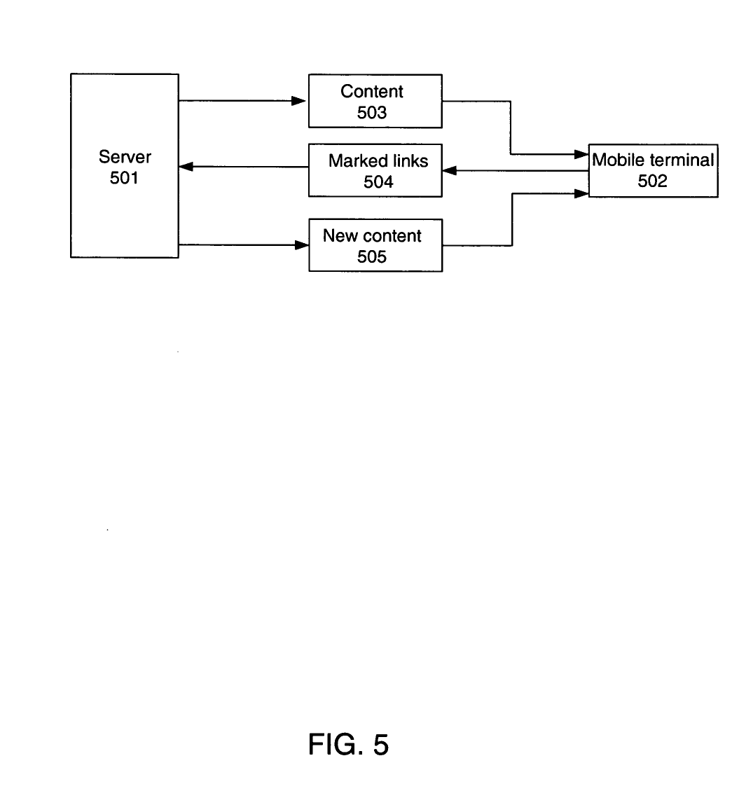

FIG. 5 is a partial block diagram illustrating an example of a server 501 providing information content 503 to a mobile terminal 502. The mobile terminal 502 may receive the information content 503 from the server 501 and return marked links 504 responsive to receiving the information content 503. The marked links (such as marked URLs) may correspond to information of interest to a user at the mobile terminal having been marked as such by the user. At the server, the marked links may be included in a user profile for determining the interests of the user. Based on the user profile and/or the marked links, new content 505 (e.g., including advertising corresponding to the user profiles) may be transmitted to the mobile terminal.

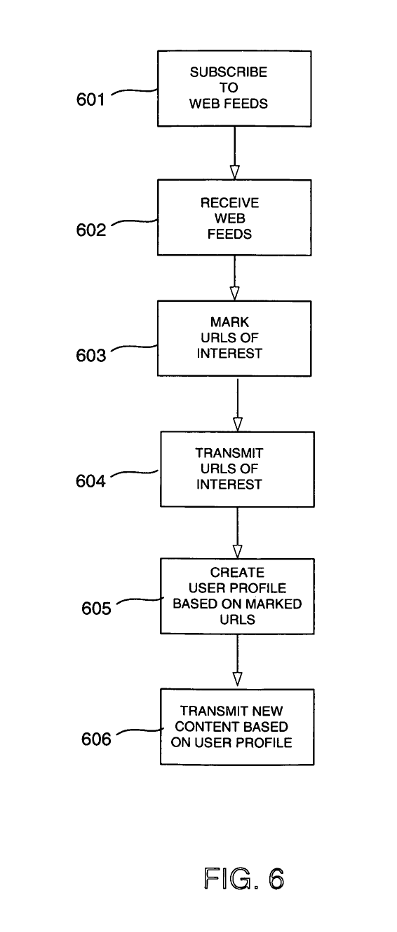

FIG. 6 shows various steps that may be carried out according to one variation of a method of the invention. In step 601, a user of a mobile terminal subscribes to one or more web feeds and, in step 602, receives content from the web feeds. In step 603, the user marks one or more URLs for the feeds that are of interest. In step 604, the marked URLs are transmitted to another computer (or, alternately, stored internally in the mobile terminal). In step 605, a user profile is created based on the URLs marked by the user. Finally, in step 606, new content is transmitted to the user based on the user profile.

In one embodiment, a computer-readable medium is provided containing instructions for performing various steps as described above and in FIG. 6.

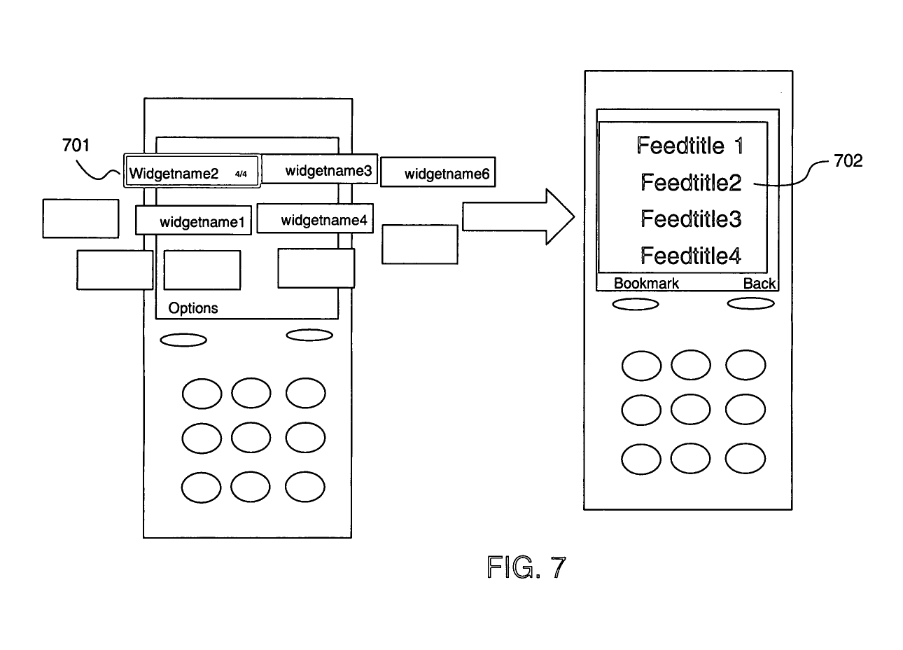

FIG. 7 shows how a widget may be selected and associated with one or more web feeds. The left side of FIG. 7 shows how widgets may be viewed on a mobile device (e.g., by using arrow keys, a joystick, tab, or other means), such as by panning the widgets across the display. Widgetname 2 701 has been selected by the user in this example, as indicated in bold. The notation 4/4 in Widgetname 2 701 indicates that there are 4 unread links out of 4 total links. The user can mark (e.g., by a softkey bookmark function) Feedtitle 2 702 to cause it to be saved in the server according to various aspects of the invention. By clicking on Feedtitle 2, the user is able to see additional content on the display associated with that link. When the title is clicked, the title changes from bold to non-bold text.

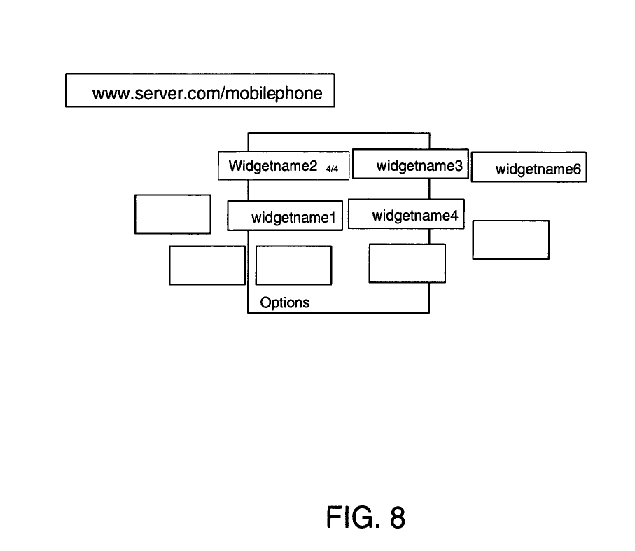

FIG. 8 shows how widgets may be created on a server for later use by a user of a mobile device from, for example, a website. In one variation, users can view the user interface of a mobile terminal and make changes to widgets and then load them into the mobile terminal to see how they would appear. Widgets can be maximized and relevant information (e.g., name of widget, RSS feed URL) can be added through a user's PC Internet connection. At the web site, the widgets can be named, selected and other information (e.g., color or images) added as icons to be shown as the widget and placement of the icon is set. According to another variation, users can monitor how much traffic a widget (e.g., an advertising widget) generates and control it by setting limits on the traffic from the server to the mobile terminal. For example:

| | | | |
|---|---|---|---|
| Widgetname1 | 30% | 124 | kb |
| Widgetname2 | 10% | 41 | kb |
| Widgetname3 | 25% | 100 | kb |
| Widgetname4 | 30% | 125 | kb |
| Widgetname5 | 5% | 20 | kb |

In the above example, the user is able to change and make selections based on traffic activity (e.g., total allowed/agreed load for 1 Mb from the server to the mobile phone). The user can change and make selections based on traffic activity, and a warning may be sent to the mobile phone if a certain limit is exceeded. Using an options menu, the user can send a message to for example disable a widget, which causes the server to send updates to the mobile phone.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended embodiments.

What is claimed is:

1. A method for creating a user profile comprising:
receiving from an electronic device one or more marked content addresses; and
creating the user profile for a user of the electronic device that identifies additional content of potential interest for the user based on the marked one or more content addresses.

2. The method of claim 1, wherein the marked content addresses correspond to content a portion of which has been viewed on the electronic device and which has been marked by a user of the electronic device.

3. The method of claim 1, further comprising the step of:
transmitting additional content that matches the user profile to the electronic device.

4. The method of claim 3, wherein the additional content comprises advertising content that matches the user profile.

5. The method of claim 1, wherein the content addresses comprise universal resource locators corresponding to web feeds, and wherein the electronic device comprises a mobile terminal.

5. The method of claim 1, further comprising the step of repeating the receiving step and adjusting the user profile based on the received content addresses.

6. The method of claim 1, further comprising the step of transmitting the marked content addresses to another computer associated with a user of the electronic device.

7. The method of claim 6, wherein the transmitting is performed via email.

8. The method of claim 6, further comprising the step of transmitting content to the other computer that matches the user profile.

9. An electronic device comprising:
means for displaying on a display unit portions of content received from a web-based content source;
means for permitting a user of the electronic device to mark selected portions of the content for later viewing of additional portions of the content; and
means for storing the marked selected portions.

10. The electronic device of claim 9, wherein the means for storing comprises a transmitter that transmits the marked selected portions to a server that generates user profiles based on the marked selected portions.

11. The electronic device of claim 9, wherein the means for storing comprises an internal storage area in the electronic device.

12. The electronic device of claim 9, wherein the means for storing comprises a transmitter that transmits the marked selected portions to a computer associated with a user of the electronic device.

13. The electronic device of claim 9, wherein the means for displaying comprises a web feed content reader on a mobile terminal.

14. The electronic device of claim 9, wherein the means for marking marks one or more universal resource locators in the content.

15. A server comprising a computer and a storage area, the computer programmed to carry out the steps of:
receiving from a mobile terminal one or more marked content addresses corresponding to content a portion of which has been viewed on the mobile terminal and which has been marked by a user of the mobile terminal; and
creating the user profile for the user of the mobile terminal that identifies additional content of potential interest for the user based on the marked one or more content addresses.

16. The server according to claim 15, wherein the computer is programmed to transmit additional content that matches the user profile to the mobile terminal.

17. The server according to claim 16, wherein the additional content comprises advertising content matching the user profile.

18. The server according to claim 15, wherein the content addresses comprise universal resource locators corresponding to web feeds.

19. The server according to claim 15, wherein the computer is programmed to repeat the receiving step and adjust the user profile based on the received content addresses.

20. The server of claim 15, wherein the computer is programmed to transmit the marked content addresses to another computer associated with a user of the mobile terminal.

21. A computer-readable medium having instructions stored thereon for performing steps comprising:
receiving from a mobile terminal one or more marked content addresses corresponding to content a portion of which has been viewed on the mobile terminal and which has been marked by a user of the mobile terminal; and
creating the user profile for the user of the mobile terminal that identifies additional content of potential interest for the user based on the marked one or more content addresses.

22. The computer-readable medium of claim 21, wherein the content addresses comprise Universal Resource Locators (URLs) corresponding to web feeds, and further comprising the step of transmitting advertisements matching criteria stored in the user profile to the mobile terminal.

23. A mobile terminal comprising:
a display unit capable of displaying web-based content received at the mobile terminal; and
a processor programmed with computer-executable instructions which, in combination with the display unit, cause the display unit to display the web-based content, receive one or more marked portions of the web-based content from a user of the mobile terminal, and cause to be stored the marked portions for use in creating a user profile identifying further content of potential interest to be later received by the user.

24. The mobile terminal of claim 23, wherein the processor is further programmed to transmit the one or more marked portions of the web-based content to another computer for creation of the user profile on the other computer.

25. The mobile terminal of claim 24, wherein the processor is further programmed to transmit universal resource locators corresponding to web feeds received at the mobile terminal to the other computer.

26. The mobile terminal of claim 25, wherein the processor is further programmed to receive and display further content of additional interest matching the user profile.
